(19) United States
(12) Patent Application Publication
(10) Pub. No.: US 2015/0362048 A1
(43) Pub. Date: Dec. 17, 2015

(54) TENSIONING RAIL HAVING AN ALSI ALLOY SUPPORT BODY

(71) Applicant: SCHAEFFLER TECHNOLOGIES GMBH & CO. KG, Herzogenaurach (DE)

(72) Inventors: Michael Kastner, Erlangen (DE); Marcus Haibach, Langensendelbach (DE)

(73) Assignee: Schaeffler Technologies AG & Co. KG, Herzogenaurach (DE)

(21) Appl. No.: 14/763,971

(22) PCT Filed: Oct. 8, 2013
(86) PCT No.: PCT/DE2013/200207

§ 371 Date: Jul. 28, 2015

(30) Foreign Application Priority Data
Jan. 29, 2013 (DE) 10 2013 201 334.5

(51) Int. Cl. F16H 7/18; F16H 7/08

(52) U.S. Cl. CPC F16H 7/18; F16H 7/08; F16H 2007/185; F16H 2007/0872

(57) ABSTRACT

Tensioning rail for tensioning a traction element (3) which slides along on the tensioning rail, the tensioning rail being arranged in a fraction drive of an internal combustion engine and having a support body (1) that is mounted pivotably about a rotation axis (2). Pressure is applied to the distal end of the support body in the direction of the traction element (3) by a tensioning element (4). The support body (1) is produced by way of die-casting from a hypereutectic or eutectic alloy that contains both aluminum and silicon.

### FIELD OF THE INVENTION

The present invention relates to a tensioning rail for tensioning a traction element which slides along on the tensioning rail, the tensioning rail being arranged in a traction drive of an internal combustion engine. The tensioning rail has a support body which is mounted pivotably about an axis of rotation and is subjected to pressure in the direction of the traction element at its distal end by a tensioning element.

### BACKGROUND

A tensioning element of the aforementioned generic type is known from the document DE 4212309 A1. This document claims a tensioning rail with an aluminum support body. A support body made of aluminum has the advantage that it is lighter than steel but has a greater temperature resistance than plastic. In order that the support body has a high strength, in order to withstand the traction forces which act on it, the support body produced from cast aluminum has a double-T cross section according to the invention. However, it is not only the force of the traction means which acts on the support body, but also the compressive force of the engaging tensioning element. Usually, the tensioning element is a pressurized metallic piston made of steel or aluminum which acts on the tensioning rail or the support body at a supporting point. Due to vibrations which are transferred by the traction element onto the tensioning rail and therefore onto the support body and the supporting point thereof, contact pressure arises in this region. Due to permanent loading, this leads to wear on the support body. In order to counteract this, it is common, as can also be gathered from the figures of the aforementioned document, to provide the supporting point of the support body with a steel pin by pressing the latter into the support body. The steel pin allows for a relatively high contact pressure and prevents wear on the support body in the region.

### SUMMARY

The invention is based on the object of providing a support body which is cost-effective to produce, has a low weight and is resistant to wear in spite of loading.

The object is achieved according to the invention by virtue of the fact that the support body is produced by means of die-casting methods from a eutectic or even hypereutectic alloy comprising both aluminum and silicon.

For definition, it should be explained that a eutectic denotes a mixture of two or else more substances which by all means is immiscible in the solid state and is entirely miscible only in the molten state. All alloying components which are segregated due to their insolubility in the solid state form the microstructure of the eutectic. It is present in a very fine distribution. Hypoeutectic alloys precipitate A primary crystals plus eutectic upon solidification. Hypereutectic alloys precipitate B primary crystals and eutectic. Near-eutectic alloys are materials near to the eutectic composition. In the case of an alloy formed of aluminum with silicon, in which the silicon makes up more than 12% of the mass of the total alloy, primarily silicon crystals which reduce the thermal expansion and the wear are precipitated in the case of a hypereutectic AlSi alloy.

Depending on the silicon proportion in the mass of the AlSi alloy, what is obtained is a eutectic or hypereutectic AlSi alloy used in the production of a support body by means of die-casting methods. A particular advantage of such a support body consists in the fact that it has a low weight due to the high aluminum content, but has a higher strength than the conventional aluminum support bodies due to the precipitated silicon crystals. The supporting point therefore also has a greater hardness than a support body made of aluminum. A particular advantage arises from the fact that an additional steel pin is no longer required for withstanding the contact pressure which arises at the supporting point. The eutectic or hypereutectic AlSi alloy provides the support body with the sufficient wear resistance at the supporting point. Costs can be saved through the omission of an additional component and the assembly thereof

In a concrete embodiment of the invention, it is proposed to use a hypereutectic AlSil4 alloy, since in practice good results have already been achieved thereby.

Further constituents can optionally be added to the AlSi alloy for uniformly distributing and refining the primary silicon crystals. According to a report by O. Zak, H. Zak and B. Tonn (“Einsatz von rasch erstarrten Vorlegierungen zur Feinung des Primärsiliziums übereutektischer AlSil7Cu4Mg-Legierung” [Use of Rapidly Solidified Prealloys for Refining the Primary Silicon of Hypereutectic AlSil7Cu4Mg Alloy]), additional elements such as arsenic, selenium, beryllium, tellurium, lithium and also tungsten, manganese, molybdenum, sulfur or even magnesium are said to be suitable for the refining.

### BRIEF DESCRIPTION OF THE DRAWINGS

An embodiment of the invention is shown in FIGS. 1 to 3 and is described in detail hereinbelow, the invention not being restricted to this exemplary embodiment.

In the drawings:

FIG. 1 shows a section of an aluminum support body from the prior art,

FIG. 2 shows a support body according to the invention consisting of AlSil4 alloy, and

FIG. 3 shows an aluminum-silicon phase diagram.

### DETAILED DESCRIPTION OF THE PREFERRED EMBODIMENTS

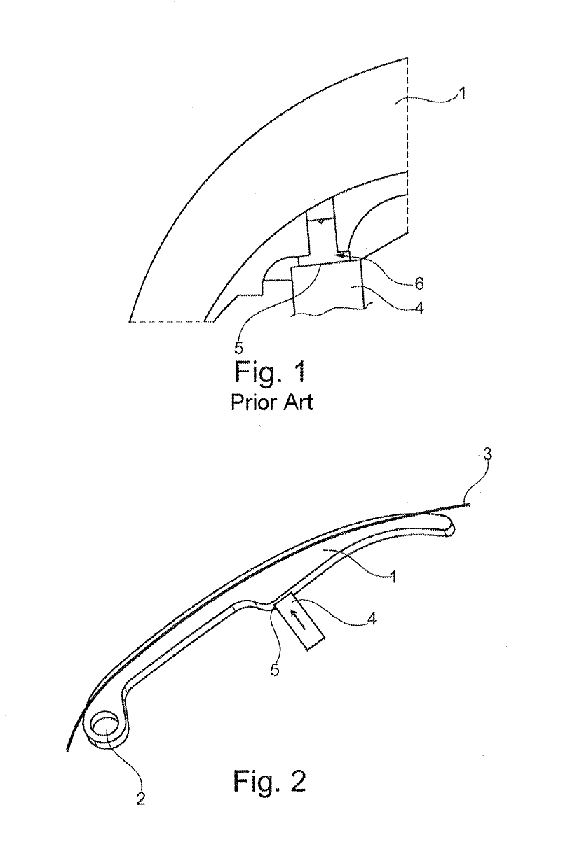

FIG. 1 shows a detail of a support body 1 of a tensioning rail as is known from the prior art. A tensioning element 4 comes to rest at a supporting point 5 of the support body 1. In order to save weight, the support body 1 is manufactured from aluminum, the tensioning element 4 in most cases being manufactured from steel. Due to the contact pressure between the tensioning element 4 and the support body 1, a steel pin 6 has been pressed into the support body 1 at the site of the supporting point 5 of the support body, such that wear does not arise on the support body 1. This has the disadvantage that two components (1, 6) of differing materials with different coefficients of thermal expansion have to be connected and assembled by an additional working step.

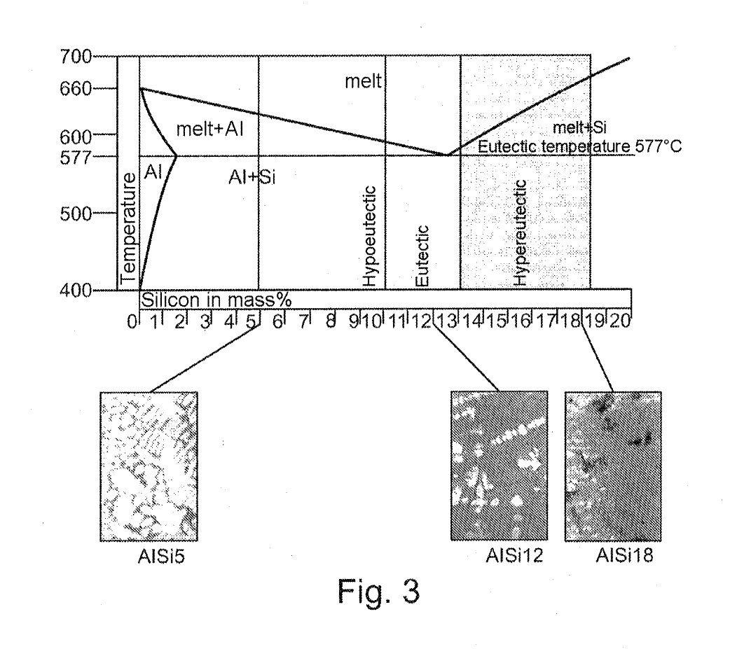

FIG. 2 shows a support body 1, according to the invention, of a tensioning rail, on which a traction element 3 to be tensioned runs. The support body 1 is mounted pivotably about a center of rotation 2. The tensioning element 4 comes to rest at the supporting point 5 of the support body 1 and moves the latter in the direction of the arrow against the traction means 3 to be tensioned. The support body 1 according to the invention is cast from an AlSil4 alloy. As can be gathered from the aluminum-silicon phase diagram in FIG. 3, this means that the alloy mass consists of 14% silicon, this mixing after a heat treatment to form a hypereutectic alloy in which primarily silicon crystals are precipitated. Due to the precipitated silicon crystals, the strength of the support body 1 produced with this alloy is increased and the wear of said support body at the pressure point 5 is reduced. It is thereby possible to dispense with the additional steel pin 6 as shown in FIG. 1 entirely.

### LIST OF REFERENCE NUMERALS

1 Support body
2 Center of rotation
3 Traction element
4 Tensioning element
5 Supporting point
6 Steel pin

1. A tensioning rail for tensioning a traction element which slides along on the tensioning rail, the tensioning rail being arranged in a traction drive of an internal combustion engine and comprising a support body (1) which is mounted pivotably about an axis of rotation (2) and is subjected to pressure in a direction of the traction element (3) at a distal end thereof by a tensioning element (4), the support body is die-cast from a eutectic alloy comprising both aluminum and silicon.

2. The tensioning rail as claimed in claim 1, wherein the support body is die-cast from a hypereutectic alloy comprising both the aluminum and the silicon.

3. The tensioning rail as claimed in claim 2, wherein the alloy of the support body is an AlSi14 alloy.
